(19) United States
(12) Patent Application Publication
(10) Pub. No.: US 2006/0171512 A1
(43) Pub. Date: Aug. 3, 2006

(54) Figure having answering device

(76) Inventors: Michelle Staudenmeier, Gaithersburg, MD (US); Joan Diehl, Alexandria, VA (US)

Correspondence Address: BLANK ROME LLP, 600 NEW HAMPSHIRE AVENUE, N.W., WASHINGTON, DC, 20037, US

(21) Appl. No.: 11/312,689

(22) Filed: Dec. 21, 2005

Related U.S. Application Data
(60) Provisional application No. 60/637,866, filed on Dec. 22, 2004.

(51) Int. Cl. H04M 1/64

(52) U.S. Cl. 379/82

(57) ABSTRACT

An elongated statute has a widened base for receiving a fluid-filled container. The container retains a plastic indicator which floats in the liquid retained within the container. The bottom of the answering device has a clear window through which the indicator can be seen. The statute has a religious shape which conveys authority and/or promotes reliance on the message conveyed by the answering device. The messages displayed match the article in which the answering device is located.

### RELATED APPLICATION

This application claims priority to provisional application Ser. No. 60/637,866, filed Dec. 22, 2004, which is hereby incorporated by reference.

### BACKGROUND OF THE INVENTION

1. Field of the Invention

The present invention relates to answering devices. More particularly, the present invention relates to the use of an answering device in a figurine.

2. Background of the Related Art

The conventional predictive or answering device is shown in U.S. Pat. No. 3,119,621 to Bookman. In that patent, the answering device is a die placed in a clear fluid-filled chamber. The chamber is located inside a shell which forms an object. The object is a sphere having a flat portion, through which the die can be viewed inside the chamber. The well-known “MAGIC 8 BALL” also has a spherical shape to replicate an enlarged ball used to play pool.

However, the chamber takes up a substantial portion of the inner portion of the shell in the Bookman patent. In addition, the object is rather short and is not much larger than the chamber.

### SUMMARY OF THE INVENTION

Accordingly, it is an object of the invention to provide an answering device that is suitable for use with elongated objects, such as figurines or statutes. It is another object of the invention to provide an answering device within an object that conveys authority and promotes reliance on the message conveyed by the answering device.

In accordance with these and other objects of the invention, an elongated statute is provided having a widened base for receiving a fluid-filled container. The container retains a plastic indicator, preferably in the form of a icosahedron, which floats in the liquid retained within the container. The bottom of the answering device has a clear window through which the indicator can be seen. The statute has a religious or other shape which conveys authority and/or promotes reliance on the message conveyed by the answering device. The messages displayed match the article in which the answering device is located.

These and other objects of the invention, as well as many of the intended advantages thereof, will become more readily apparent when reference is made to the following description, taken in conjunction with the accompanying drawings.

### BRIEF DESCRIPTION OF THE FIGURES

FIG. 1 is a front view of an answering device in accordance with the preferred embodiment of the invention.

FIGS. 2-6 show alternative embodiments of the invention.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents that operate in similar manner to accomplish a similar purpose.

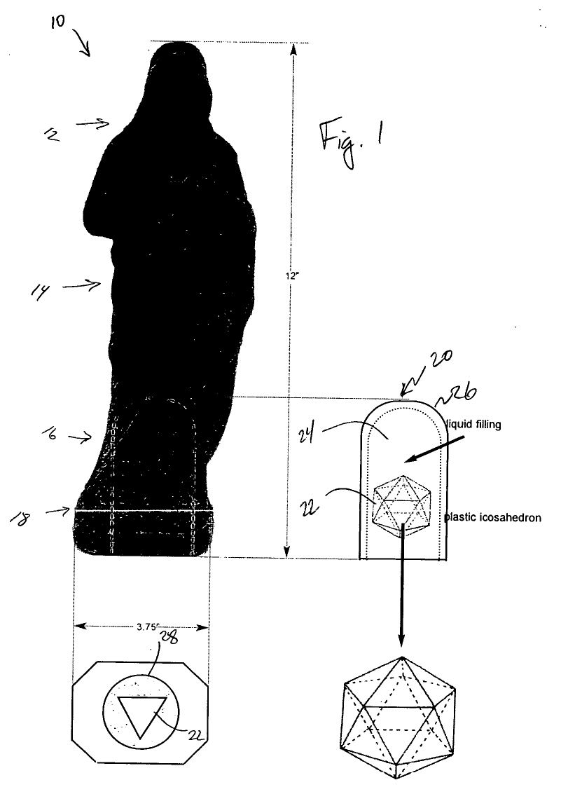

Turning to the drawings, FIG. 1 shows a figurine or statute device 10 having a head section 12, middle section 14, bottom section 16, and a base or pedestal 18. An answering device 20 (e.g., as in the “MAGIC 8-BALL”) is fitted in the bottom section 16 and base 18 of the device 10. The answering device 20 includes a plastic indicator 22, preferably in the form of a icosahedron (though can have any suitable number of sides, such as 8 or 10), which floats inside of a liquid filling 24 retained within a sealed insert or container 26. The bottom of the answering device 20 has a clear window 28 through which the indicator 22 can be seen. The side of the indicator 22 that floats to the window 28 can be viewed through the window 28 when the device 10 is inverted. In accordance with the preferred embodiment, the device 10 has a religious shape.

The container 26 must be of a size sufficient to permit the indicator 22 to freely move about within the liquid without undue restriction. The size of a standard container 20 is typically about 3-3.5 inches in height, and 2-2.5 inches in width. However, the size of the container places restrictions on the size of the figurine that can be portrayed by the device 10 since the device 10, and particularly the bottom section 16, must be larger than the container 26. The container size is chosen so that it is sufficiently large to add stability to the statute, but not too large to fit in the device 10. Preferably, the device 10 is elongated, having a height of 11 inches and a width at the base of about 4 inches inches. The preferred container 26 is about 4 inches long and 1.5 inches wide. For a device 10 having a height of 6 inches, the preferred container 26 is about 2 inches long.

Preferably, the figurine is a religious figure or other article or shape which represents authority and/or promotes reliance on the message that is conveyed by the answering device. However, the figurine can also be a celebrity, a political person, existing character, symbol, or the like. The device 10 can also be combined with novelties such as, for instance, a bobble head, plushes, and/or an audible answering device or with other functional items, such as a bank (i.e., piggy bank), or keychain. The messages printed on the faces of the indicator 22 can be customized to match the type of article that it is contained within.

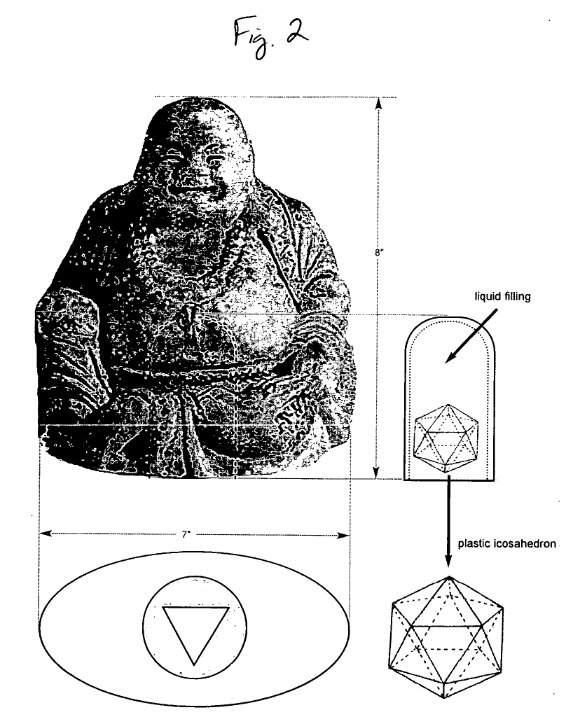

The answering device 20 is preferably located in the base of the device 10, but can also be located elsewhere on the device, such as at the middle section 14. The answering device 20 can be fitted to the figurine in any suitable manner, such as by adhesive or a locking member. The device 10 can be made of plastic and painted or covered with flock or other material, or can be made of wood, metal, or cloth. FIG. 2 is another embodiment of the device having a religious figure with an oval cross-section shape.

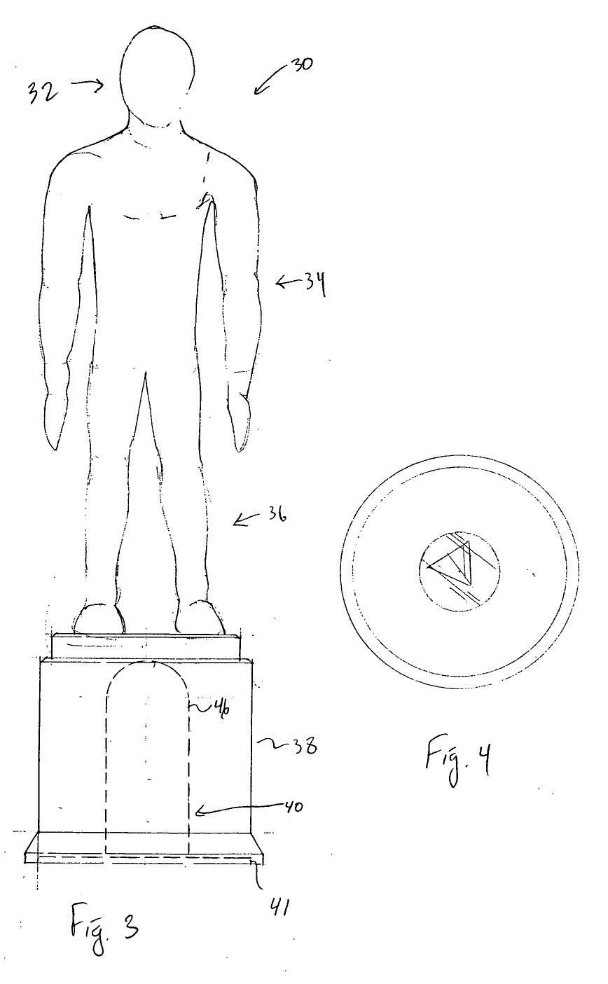

FIGS. 3-4 show another embodiment of the invention, in which a figurine device 30 has a head section 32, middle section 34, bottom section 36, and pedestal 38. Here, the figurine has a bottom section 36 which is too narrow to fit an answering device. Accordingly, the bottom section 36 is attached to a pedestal 38 that has a sufficient size to accommodate the answering device 40. The pedestal 38 may also be of sufficient weight to prevent the device 10 from tipping over. An opening is cut into the pedestal 38 to fit the insert 46, which is then secured to the device 10 in any conventional manner. The bottom of the pedestal 38 can have a depressed center 41, so that the answering device does not contact the surface on which the device 10 is placed. The pedestal can be of any suitable size and shape.

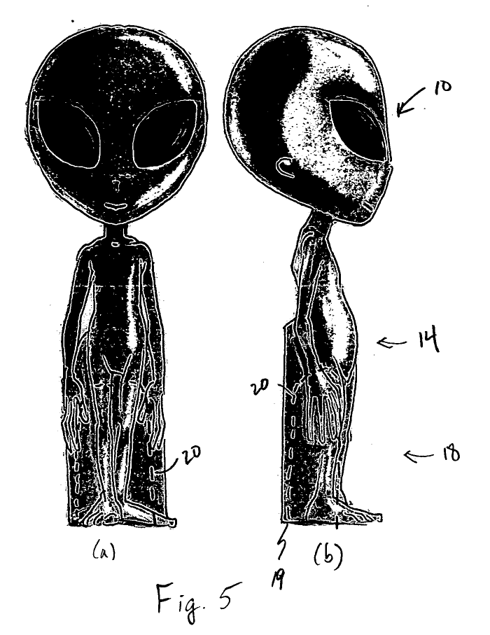

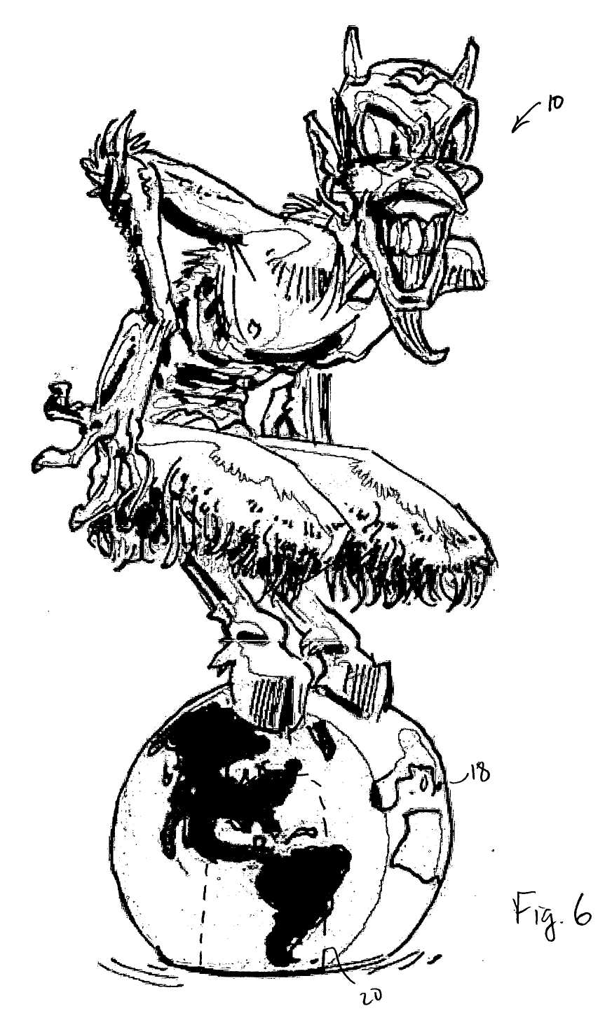

FIG. 5 shows another embodiment of the invention, in which the figurine itself has narrow middle and bottom sections 14, 16. These sections 14, 16 are widened by integrating the figurine with a support member 19. The support member 19 is sufficiently wide so that the device 10 is able to receive the answering device 20.

FIG. 6 shows another embodiment of the invention, in which the pedestal 18 is in the form of a globe. Of course, the shape of the pedestal 18 is not critical, and any suitable shape can be used.

The foregoing description and drawings should be considered as illustrative only of the principles of the invention. The invention may be configured in a variety of shapes and sizes and is not intended to be limited by the preferred embodiment. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

1. A statute comprising:
a top section,
a bottom section substantially wider than the top section, and
a fluid-filled container located within said bottom section, said container retaining an indicator that displays messages.

2. The statute of claim 1, wherein said statute comprises a religious figure.

3. The statute of claim 1, wherein said bottom section comprises a pedestal and the top section comprises a figure.

4. The statute of claim 1, wherein said statute comprises a figure that conveys authority or promotes reliance on the messages.

5. The statute of claim 1, wherein said container is weighted to provide stability to the statute.

6. The statute of claim 5, wherein said container prevents said statute from tipping over.

7. The statute of claim 1, wherein the indicator freely floats within said container.

8. The statute of claim 1, wherein the statute is elongated.

9. A figurine comprising:
a top section,
a bottom section substantially wider than the top section, and
a fluid-filled container located within said bottom section, said container retaining an indicator that displays messages.

10. The figurine of claim 9, wherein said figurine comprises a religious figure.

11. The figurine of claim 9, wherein said bottom section comprises a pedestal and the top section comprises a figure.

12. The figurine of claim 9, wherein said figurine comprises a figure that conveys authority or promotes reliance on the messages.

13. The figurine of claim 9, wherein said container is weighted to provide stability to the figurine.

14. The figurine of claim 13, wherein said container prevents said figurine from tipping over.

15. The figurine of claim 9, wherein the indicator freely floats within said container.

16. The figurine of claim 9, wherein the figurine is elongated.
